(19) United States
(12) Patent Application Publication
(10) Pub. No.: US 2024/0175989 A1
(43) Pub. Date: May 30, 2024

(54) PSEUDO MONOSTATIC LIDAR WITH TWO-DIMENSIONAL SILICON PHOTONIC MEMS SWITCH ARRAY

(71) Applicant: nEYE Systems, Inc., Berkeley, CA (US)

(72) Inventors: Tae Joon SEOK, El Cerrito, CA (US); Ming Chiang A. WU, Piedmont, CA (US)

(21) Appl. No.: 18/446,711

(22) Filed: Aug. 9, 2023

Related U.S. Application Data
(63) Continuation of application No. 17/687,372, filed on Mar. 4, 2022, now Pat. No. 11,754,683.
(60) Provisional application No. 63/186,748, filed on May 10, 2021.

(51) Int. Cl. G01S 7/481; G01S 17/42; G01S 17/89; G01S 17/931

(52) U.S. Cl. CPC G01S 7/4817; G01S 7/4811; G01S 7/4818; G01S 17/42; G01S 17/89; G01S 17/931

(57) ABSTRACT

The present disclosure is directed to imaging LiDARs with separate transmit (Tx) and receive (Rx) optical antennas fed by different optical waveguides. This pair of optical antennas can be activated at the same time through a dual-channel optical switch network, with the Tx antenna connected to a laser source and the Rx antenna connected to a receiver. The Tx and Rx antennas can be positioned adjacent to each other, so they point to approximately the same far-field angle. No optical alignment between the Tx and Rx is necessary. This LiDAR configuration, referred to herein as pseudo-monostatic LiDAR, eliminates spurious reflections and increases the dynamic range of the LiDAR.

### CROSS REFERENCE TO RELATED APPLICATIONS

This patent application is a continuation of U.S. patent application Ser. No. 17/687,372, filed Mar. 4, 2022, titled “PSEUDO MONOSTATIC LIDAR WITH TWO-DIMENSIONAL SILICON PHOTONIC MEMS SWITCH ARRAY” which claims priority to U.S. Provisional Patent Application No. 63/186,748 filed May 10, 2021, and titled “PSEUDO MONOSTATIC LIDAR WITH TWO-DIMENSIONAL SILICON PHOTONIC MEMS SWITCH ARRAY,” herein incorporated by reference in its entirety.

### FIELD

The present disclosure details novel LiDAR systems and methods. More specifically, this disclosure is directed to imaging LiDARs with separate transmit (Tx) and receive (Rx) optical antennas fed by different optical waveguides.

### BACKGROUND

Light detection and ranging (LiDAR) is widely used in autonomous vehicles and portable devices such as smartphones and tablets. Solid state LiDARs are particularly attractive because they are conducive to miniaturization and mass production. US Patent Pub. No. 2021/0116778 teaches a beamsteering system consisting of a programmable array of vertical couplers (also called optical antennas) located at the focal plane of an imaging lens. Optical signal can be delivered to any selected optical antenna through a programmable optical network consisting of MEMS (micro-electro-mechanical system)-actuated waveguide switches. Compared with conventional thermo-optic or electro-optic switches, the MEMS switches offer lower insertion loss, lower crosstalk, broadband operation, and digital actuation. High density arrays of programmable optical antennas can be integrated on single chips for high resolution imaging LiDARs, thanks to their small footprint.

Previous work used the same optical antenna to transmit the interrogating optical beam and receive the optical signal reflected from the target. A drawback of this architecture is that any residue reflections from the optical antenna and the shared optical path will be mixed with the received optical signals. The spurious reflections degrade the signal-to-noise ratio and could saturate the amplifiers in the receiver, preventing the LiDAR from seeing far-away targets or targets with low reflectivity.

### SUMMARY OF THE DISCLOSURE

A pseudo-monostatic imaging LiDAR system is provided, comprising a lens, at least one light emitter, at least one light detector, a plurality of paired optical antennas each comprising a transmit optical antenna and a receive optical antenna, and a programmable optical network configured to provide a first light path from the at least one light emitter to a selected transmit optical antenna, the programmable optical network being further configured to provide a separate second light path from a receive optical antenna paired to the selected transmit optical antenna to the at least one light detector, wherein the plurality of paired optical antennas are positioned at or around a focal plane of the lens.

In some embodiments, the plurality of paired optical antennas and the programmable optical network are integrated on a photonic integrated circuit

In one implementation, the at least one light emitter is a frequency-modulated continuous-wave laser, and the at least one light detector is a coherent optical receiver comprising balanced photodetectors or in-phase/quadrature double balanced photodetectors, wherein a fraction of the at least one light emitter is tapped off by a 1×2 coupler to produce a local oscillator of the coherent receiver.

In one example, the at least one light detector is integrated into a pixel, the pixel comprising a 1×2 optical switching unit, a 1×2 coupler to split a fraction an output of the at least one light emitter to produce a local oscillator, a transmit optical antenna, a paired receive optical antenna, and a coherent receiver configured to receive optical signals from at least one receive optical antenna and the local oscillator.

In some embodiments, the at least one light detector is shared by a plurality of pixels, each pixel comprising the selected transmit optical antenna, the receive optical antenna paired to the selected transmit optical antenna, a dual-channel 1×2 optical switch comprising two parallel switches connecting an optical bus waveguide to the selected transmit optical antenna and a second optical bus waveguide connected to the receive optical antenna paired to the selected transmit optical antenna, wherein the programmable optical network is programmed to provide a light path from at least one light emitter to the selected transmit optical antenna and a physically separate light path from the receive optical antenna paired to the selected transmit optical antenna to the at least one light detector.

In some examples, optical energy from the at least one light emitter is delivered to multiple selected pixels through an optical splitter or optical amplifier.

In one embodiment, a separate light emitter is used for each group of pixels.

In some examples, the at least one light emitter or the at least one light detector, or both, are integrated on the photonic integrated circuit.

In one embodiment, the at least one light emitter or the at least one light detector, or both, are integrated on a separate second photonic integrated circuit and coupled to the photonic integrated circuit.

In some embodiments, the at least one light emitter or the at least one light detector, or both, are connected to the photonic integrated circuit by optical fibers, polymer waveguides, other type of waveguides, or coupled through free-space with optical elements such as lenses or grating couplers.

In other embodiments, the transmit optical antenna and the receive optical antenna of the plurality of paired optical antennas are side by side in the same optical layer.

In one embodiment, the transmit optical antenna and the receive optical antenna of the plurality of paired optical antennas are integrated vertically on separate optical layers.

In some examples, the transmit optical antenna and the receive optical antenna of the plurality of paired optical antennas have orthogonal polarizations, and wherein the system further comprises a quarter-wave plate disposed before or after the optical lens.

In other embodiments, each receive optical antenna of the plurality of paired optical antennas comprise two antennas with orthogonal polarizations and are configured to detect reflected optical signals in both of the orthogonal polarizations.

In some implementations, the programmable optical network is controlled by one or more micro-electro-mechanical system (MEMS) actuators, or Mach-Zehnder interferometers with electro-optic or thermo-optic phase modulators, or microring resonators with electro-optic or thermo-optic phase modulators.

A method of performing LiDAR imaging is provided, comprising the steps of controlling a programmable optical network to provide a first light path from at least one light emitter to a selected transmit optical antenna of a paired optical antenna of the optical network, controlling the programmable optical network to provide a separate second light path from a receive optical antenna paired to the selected transmit optical antenna to at least one light detector.

In some examples, controlling the programmable optical network comprises actuating one or more MEMS switches.

In another example, actuating the one or more MEMS switches further comprises energizing one or more electrodes disposed within the one or more MEMS switches.

In some embodiments, the method further comprises delivering optical energy from the at least one light emitter to multiple selected pixels through an optical splitter.

In one embodiment, three-dimensional images are acquired by combining the range measurements of multiple pixels.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is one example of imaging based LiDAR with a monostatic array.

FIG. 2 is one example of a proposed pseudo-monostatic imaging LiDAR.

FIG. 3 illustrates a 1×M switch (row selection switch) to select the active row and a 1×N switch (column selection switch) to select the optical antenna.

FIG. 4A illustrates a monostatic array with separate input and output ports connected by a 1×2 coupler.

FIG. 4B shows an alternative embodiment of coherent LiDARs such as frequency-modulated continuous-wave (FMCW) LiDARs.

FIG. 5A shows an embodiment of a coherent pseudo-monostatic LiDAR.

FIG. 5B is a close-up view of one example of the dual channel 1×2 switch described in FIG. 5A

FIG. 5C is a detailed view of a coherent detector.

FIG. 5D is a coherent detector comprising a balanced I/Q detector to detect both the in-phase (I) and the quadrature (Q) components of the signal.

FIG. 6A shows one embodiment of a coherent detector integrated into each pixel.

FIG. 6B shows an alternative embodiment where, instead of having a coherent detector at each pixel, the coherent detector can be shared by a block of pixels.

FIG. 6C shows an alternative embodiment where optical amplifiers are used to boost optical power after the optical splitter.

FIG. 6D shows an alternative embodiment where the optical amplifiers are placed in alternative locations.

FIG. 6E shows an embodiment in which one laser and one detector are used for each block of pixels.

FIG. 7A shows an embodiment in which the lasers and the detectors are integrated on the same PIC

FIGS. 7B-7C show embodiments in which the lasers and detectors are located off chip and connected by fibers or other waveguides.

FIG. 7D shows an embodiment in which the lasers and the detectors are integrated on a separate PIC such as III-V PIC, and the two PICs are directly coupled to each other.

FIG. 8A shows an embodiment in which the Tx and Rx antennas are integrated side-by-side.

FIG. 8B shows an embodiment in which the Tx and Rx antennas are stacked vertically.

FIG. 9A-9C shows an embodiment of vertically stacked antennas.

FIG. 9D-9F is an embodiment of vertically stacked antennas, where the two optical antennas are designed to operate in two orthogonal polarizations for Tx and Rx, respectively, in which the two antennas are aligned parallelly without the 90-degree rotation.

FIG. 10 illustrates one embodiment of the imaging LiDAR employs a quarter-wave plate between the antennas and the targets.

### DETAILED DESCRIPTION

The present disclosure is directed to imaging LiDARs with separate transmit (Tx) and receive (Rx) optical antennas fed by different optical waveguides. In some embodiments, the optical antennas can be grating couplers, photonic crystals, resonant couplers, 45-degree (or other angle) mirrors, prism couplers, or tilted waveguides. This pair of optical antennas can be activated at the same time through a dual-channel optical switch network, with the Tx antenna connected to a laser source and the Rx antenna connected to a receiver. The Tx and Rx antennas can be positioned adjacent to each other, so they point to approximately the same far-field angle. No optical alignment between the Tx and Rx is necessary. This LiDAR configuration, referred to herein as pseudo-monostatic LiDAR, eliminates spurious reflections and increases the dynamic range of the LiDAR.

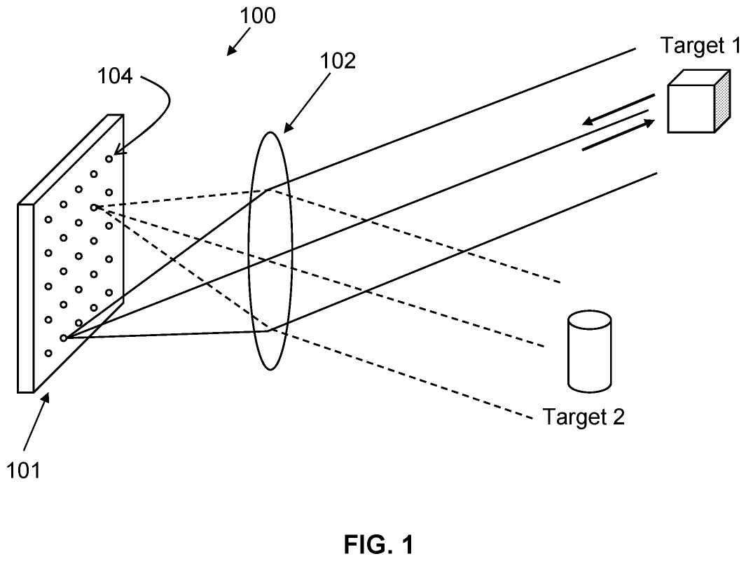

One example schematic of a monostatic imaging LiDAR 100 is shown in FIG. 1. A photonic integrated circuit (PIC) 101 with a two-dimensional (2D) array of optical antennas is placed at the focal plane of an imaging lens 102. An optical switch network in the PIC selectively activates one or more optical antennas 104 at a time. Each activated optical antenna transmits light to a certain direction (Tx) and the same antenna receives reflected light from target (Rx). This creates a one-to-one mapping between the lateral position of the optical antenna and the far-field angle, as illustrated by the optical beam paths from two separate optical antennas pointing to Target 1 and Target 2. This is referred to herein as monostatic LiDAR, in which the transmitter and the receiver share the same optical antenna. The Tx and the Rx far-field angles are automatically aligned, but the LiDAR receiver is susceptible to residue reflections in the shared optical path and antenna. Residue reflections can comprise unwanted reflections caused by some elements in the optical path from the light source (laser) to the target. These residue reflections can also be delivered to the receiver and they can potentially hinder the detection of the real target signal (especially for weak target signals at longer distances).

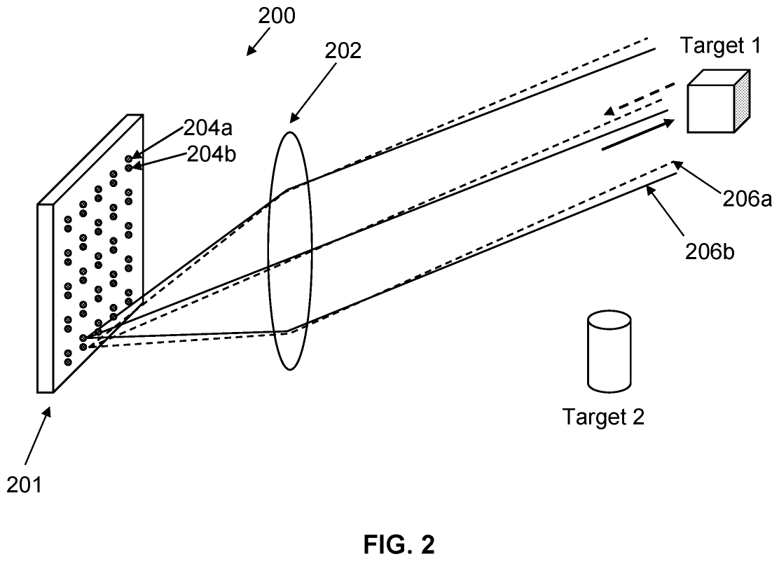

The schematic of a pseudo-monostatic imaging LiDAR 200 is shown in FIG. 2. In this embodiment, the transmitter and the receiver use separate optical antennas and separate optical waveguides to feed the transmit and receive antennas. Thus, while the embodiment of FIG. 1 included an array of optical antennas in which the antenna at each pixel location comprises a combination transmit/receive antenna, the embodiment of FIG. 2 includes a PIC 201 with an array of optical antennas with separate transmit antennas 204a and receive antennas 204b for each pixel at the focal plane of an imaging lens 202. To minimize the crosstalk between the Tx and Rx signals (e.g., leakage of signals from one channel to another), the optical antennas can be displaced on the PIC 200 either laterally (X or Y direction) or perpendicular to the focal plane (Z direction), or a combination of both. Since the far-field angle is mapped to the lateral position of the antenna, the Tx and Rx far-field angle differs slightly when the antennas are displaced in the X or Y direction, as indicated by the optical beam paths 206a and 206b in FIG. 2. The difference in far-field angle is approximately δr/f, where δr is the distance between the optical antennas in the X-Y plane and f is the focal length of the lens. Since Or is very small, the instantaneous field-of-view of the Tx and the Rx antennas have substantial overlap on targets. In another embodiment, the Tx and Rx optical antennas can be stacked vertically instead of being displaced laterally. In this case, the Tx and Rx optical antennas will point exactly in the same direction but with slightly different divergence angles. A light beam spreads and diverges more as the light propagates farther. In this example where the Tx antenna is stacked vertically with the Rx antenna, the target distance from the Tx antenna is slightly different from the target distance from the Rx antenna by the vertical displacement between the Tx and Rx antennas. The difference is very small since the separation is on the order of a micrometer.

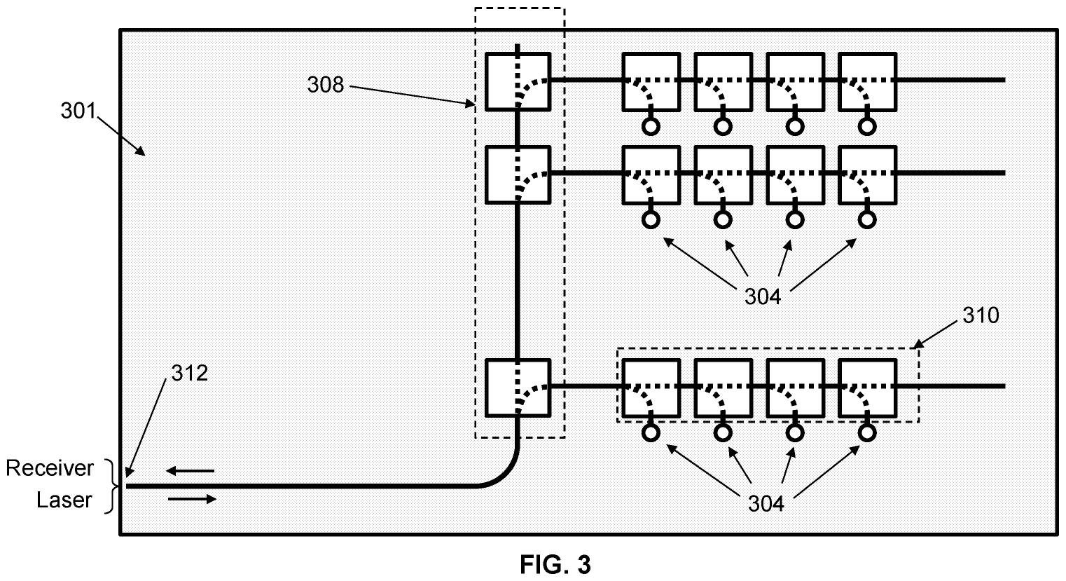

A programmable optical switch network can connect the selected Tx antenna to the laser and the Rx antenna in the same pair to the receiver. Suitable programmable optical switch networks for connecting the monostatic antenna arrays have been described by US Pub. No. US2021/0116778 which is incorporated herein by reference. FIG. 3 illustrates a programmable optical network on a PIC 301 that uses a 1×M switch (row selection switch 308) to select the active row and a 1×N switch (column selection switch 310) to select the optical antenna 304 (FIG. 3 shows a M×N array of optical antennas 304). The programmable optical network can be coupled to a receiver and a laser, as shown. The laser light is modulated, either directly or through a modulator, to generate interrogating light. In pulsed time of flight system, the laser is modulated to produce short (˜nanosecond) optical pulses, and the receivers are made of avalanche photodiodes (APD) or single photon avalanche diodes (SPAD). In frequency-modulated continuous-wave (FMCW) system, the laser frequency increases or decrease linearly with time. Coherent receivers mix the received light signals with part of the laser light (called local oscillator or LO) in p-i-n photodidoes or APDs to extract the beat frequencies. The p-i-n photodiodes or APDs are often arranged in balanced configuration to extract the difference signals. This system is referred to as FMCW LiDAR or coherent LiDAR. In this example, the 1×M switch comprises M 1×2 switches and the 1×N switch comprises N 1×2 switches. Other possible arrangements are discussed in US Pub. No. US2021/0116778. As mentioned earlier, the Tx and Rx in this embodiment share not only the optical antenna but also the common optical path including waveguides, optical switches, and the input/output coupler 312. The residue reflection from any of these components add a fraction of the Tx signal to the Rx signal. Since the Tx signal is much stronger, the reflection produces spurious signals and saturate the amplifiers in the receiver.

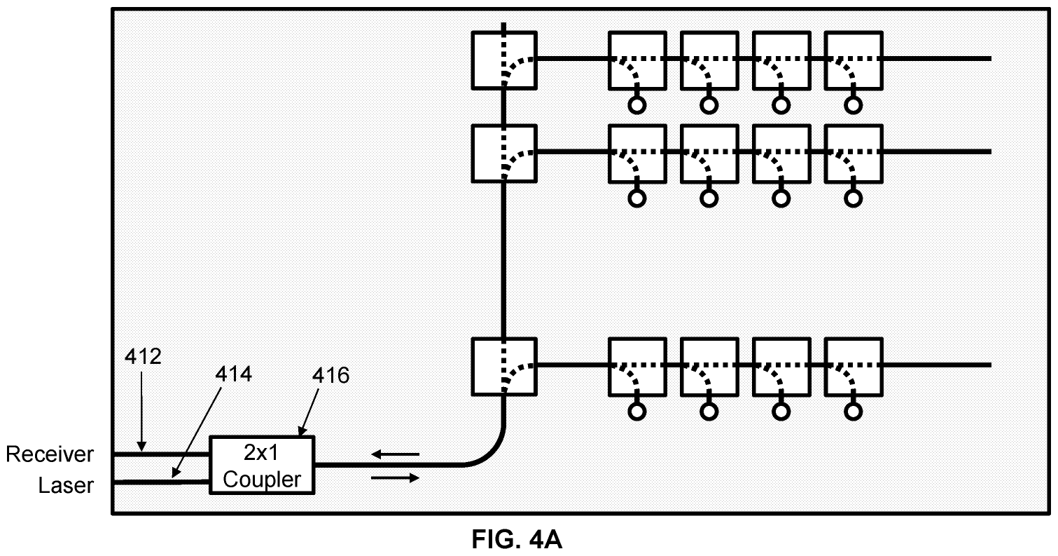

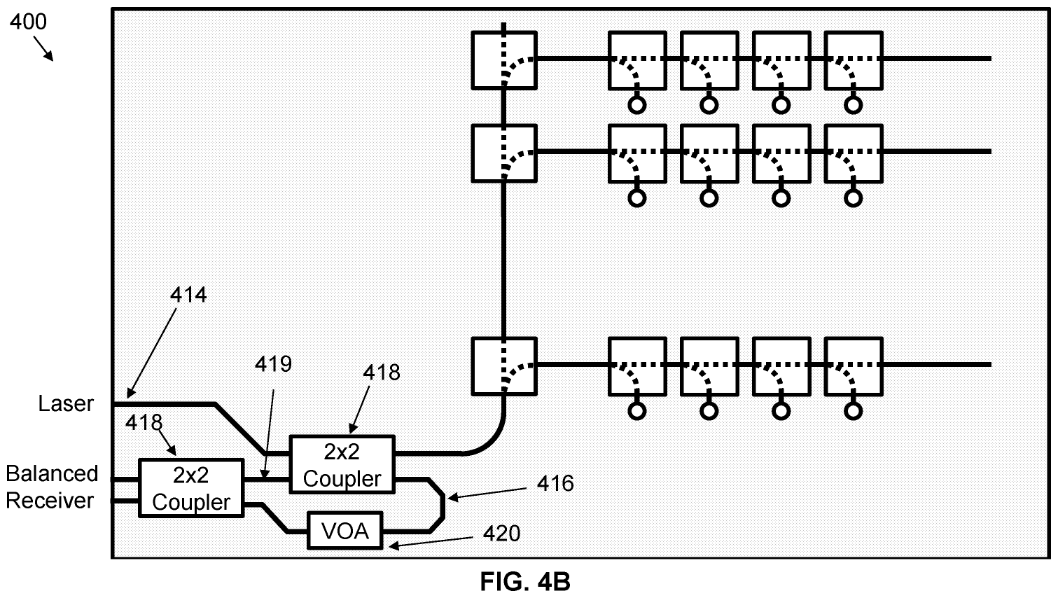

Sometimes the strongest reflections occur at the shared input/output coupler. In one embodiment, this reflection can be removed by using a separate input port 412 and output port 414 connected by a 2×1 coupler 416, as shown in the embodiment of FIG. 4A. In this implementation, however, half of the laser power and half of the received signal are lost in the 2×1 coupler.

FIG. 4B shows an alternative embodiment of coherent LiDARs 400 such as frequency-modulated continuous-wave (FMCW) LiDARs. This embodiment includes a pair of 2×2 couplers 418 optically coupled to the laser, a variable optical attenuator (VOA) 420, and a balanced receiver. Part of the laser power 416 is attenuated by VOA 420 and routed to the balanced receiver as local oscillator (LO). The LO is combined with the receiver signal (419) through the 2×2 coupler (418) and sent to balanced receiver. In either case, the LiDAR is still susceptible to residue reflections from other components.

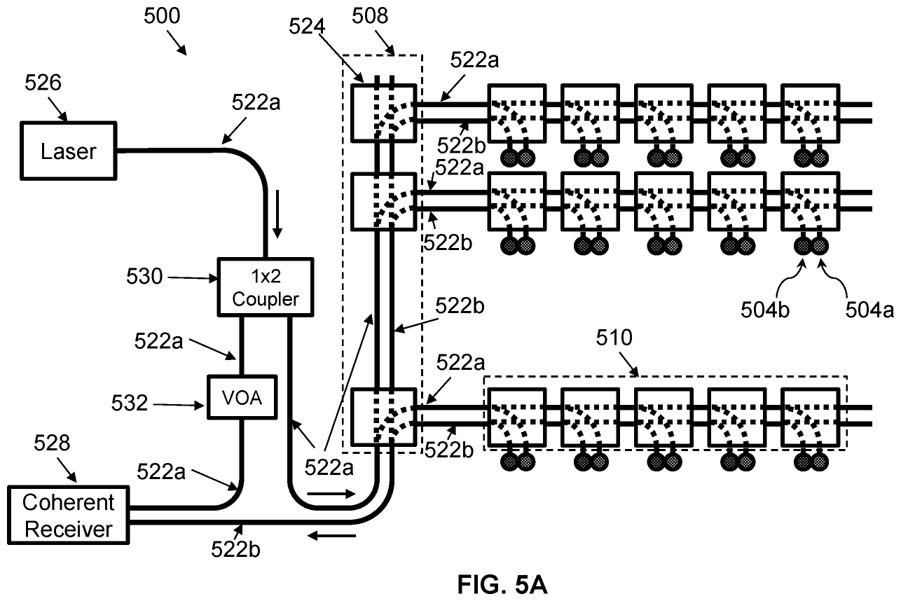

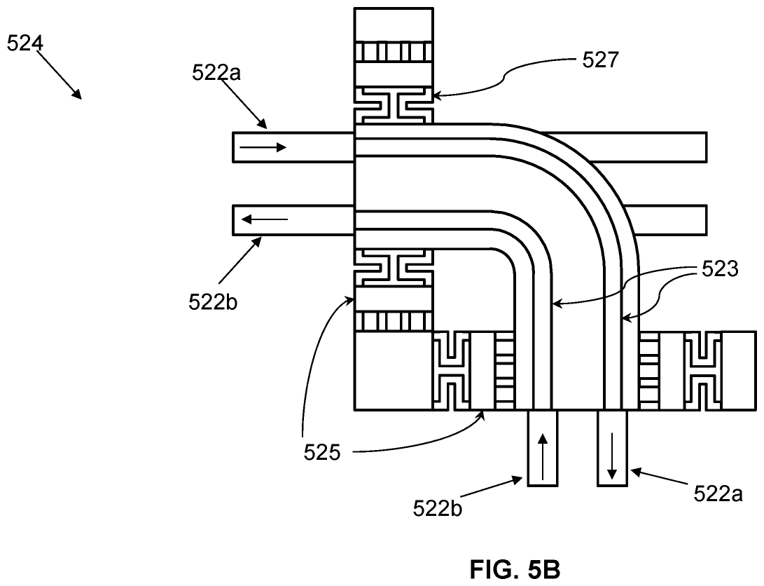

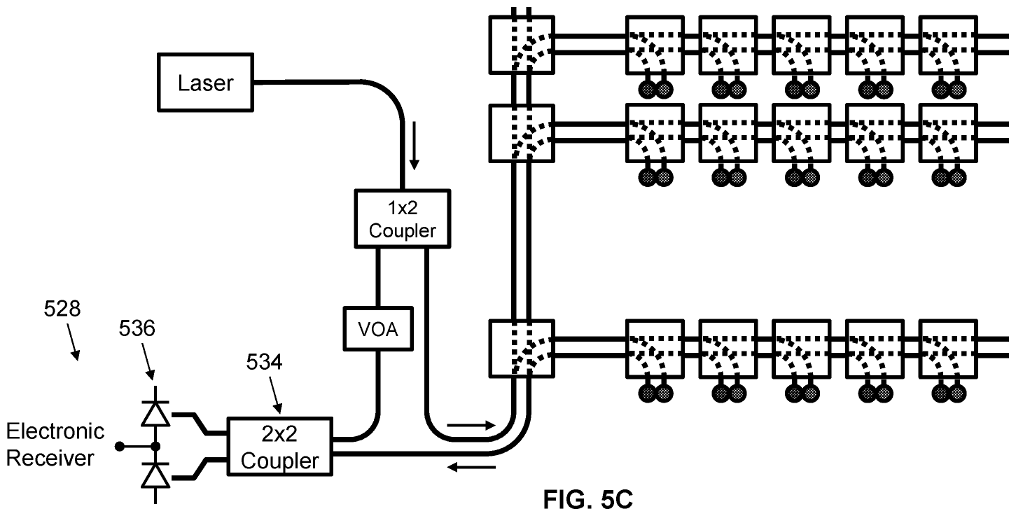

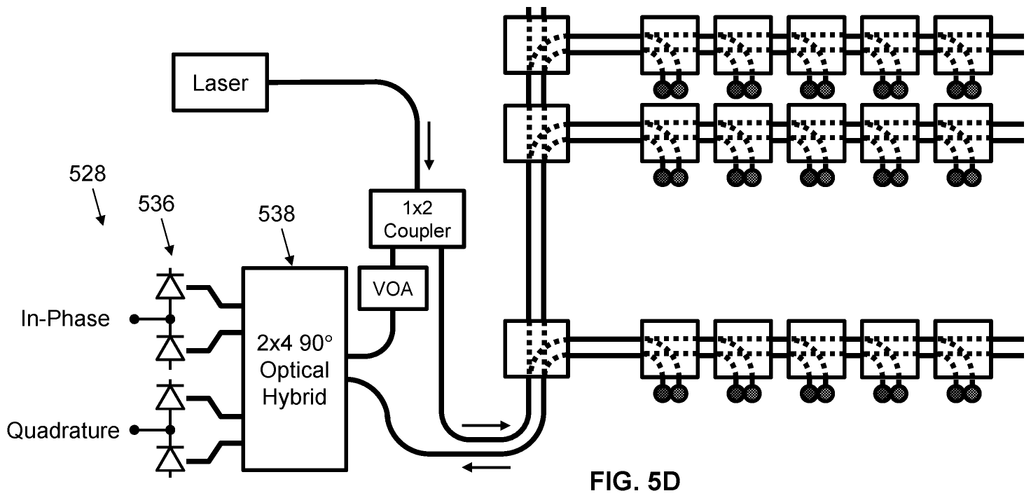

FIG. 5A shows an embodiment of a coherent pseudo-monostatic LiDAR 500. Two separate waveguides, such as transmit waveguide(s) 522a and receive waveguide(s) 522b, are used to connect the transmit (Tx) optical antennas 504a and receive (Rx) optical antennas 504b. To distribute the optical signals, the optical switch network uses dual channel 1×2 switches 524 to simultaneously select the Tx optical antennas and Rx optical antennas in the same pixel. The dual channel 1×2 switches are essentially two separate MEMS optical switches. They might share the same MEMS actuators as they are always actuated in pairs. The optical paths are physically separated to suppress optical reflections or crosstalk. The laser 526 and the receiver or coherent receiver 528 are connected to the Tx optical antennas and Rx optical antennas, respectively, by first activating a dual channel row-selection switch 508 and then activating a dual channel column-selection switch 510. Here, a small portion of the laser power is tapped off as the local oscillator (LO) by a 1×2 coupler 530 and sent to the coherent receiver 528 through the variable optical attenuator (VOA) 532 (which reduces the light power of the LO). The other split light from the laser and the 1×2 coupler is the target signal, which is sent to a target via the transmit optical antenna(s) and the reflected light from the target is received by the receive optical antenna(s) and sent to the coherent receiver 528 to be mixed (interfered) with the LO light. The coupling ratio of this coupler 530 is chosen to provide optimum power to the coherent receiver (e.g., 1% of the laser power from 526). As shown, the variable optical attenuator (VOA) can be added to finely control the LO power.

FIG. 5B is a close-up view of one example of the dual channel 1×2 switch 524 described in FIG. 5A. In this embodiment, the switch 524 is implemented as a MEMS switch. As shown, the switch 524 can include a plurality of coupler waveguides 523 optically coupled to the transmit waveguide(s) 522a and receive waveguide(s) 522b (corresponding to the same elements described in FIG. 5A). The switch 524 can further include a plurality of MEMS electrodes 525 and MEMS springs 527 connected to the plurality of coupler waveguides 523. By applying a voltage between the MEMS electrodes and the matching fixed electrodes on the substrate, the coupler waveguides will be pulled down to the close proximity of the transmit and receive waveguides through evanescent coupling. Though this embodiment uses electrostatic actuators, other MEMS actuators can be used, including, but not limited to, thermal, electrothermal, magnetic, electromagnetic, piezoelectrical actuators. Operation of the MEMS electrodes and MEMS springs brings the coupler waveguides into and out of communication with the transmit and receive waveguides, respectively. Therefore, the switch 524 can be selectively controlled to transmit light energy from the transmit/receive waveguides when desired. Since the dual channel switch shares many common structures such as the MEMS actuators and mechanical springs, it is more compact than two separate switches. The smaller footprint is advantageous for high density arrays and high-resolution imaging LiDARs. Though only two channels are shown in this embodiment, the design can be extended to higher channel count.

One embodiment of a coherent detector or receiver 528 is shown in detail in FIG. 5C. The received optical signal is mixed with the local oscillator (LO) in a 2×2 coupler 534 and detected by a pair of balanced photodiodes 536. The difference in photocurrent is amplified and processed to extract the distance and velocity of the target. In one example, the current is amplified by the electronic receiver circuitry (e.g., a trans-impedance amplifier, TIA) and the information is digitized and processed by digital signal processors such as ASIC, FPGA, etc.

In another embodiment shown in FIG. 5D, the coherent receiver 528 comprises a balanced I/Q detector to detect both the in-phase (I) and the quadrature (Q) components of the signal. Here, a 2×4 90° optical hybrid 538 is used to produce 4 different combinations of the received optical signal and LO. A pair of balanced photodetectors 536 are used to extract each of the I and Q components of the beat signal.

Though coherent LiDAR is used in this example, the same architecture can also be used for pulsed LiDAR. In that case, the LO part is not required, and the coherent receiver can be replaced by a photodiode or avalanche photodiode (APD) followed by amplifiers.

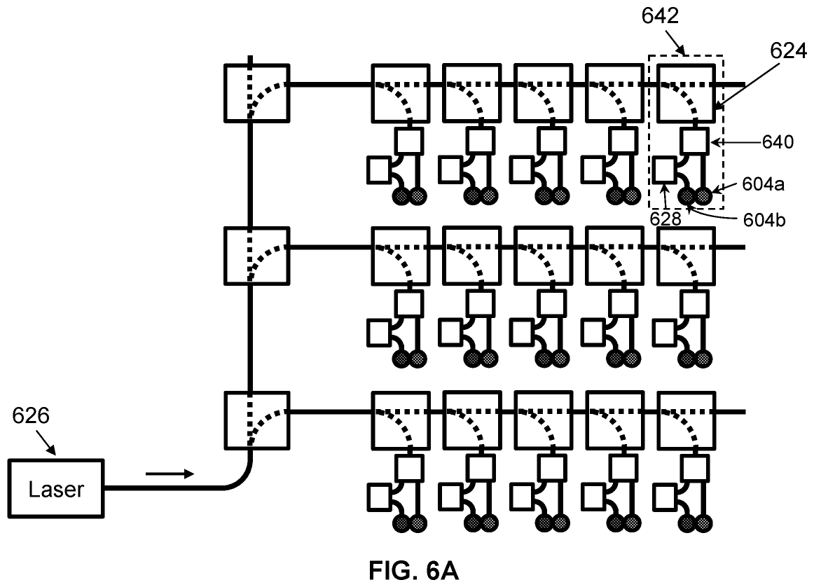

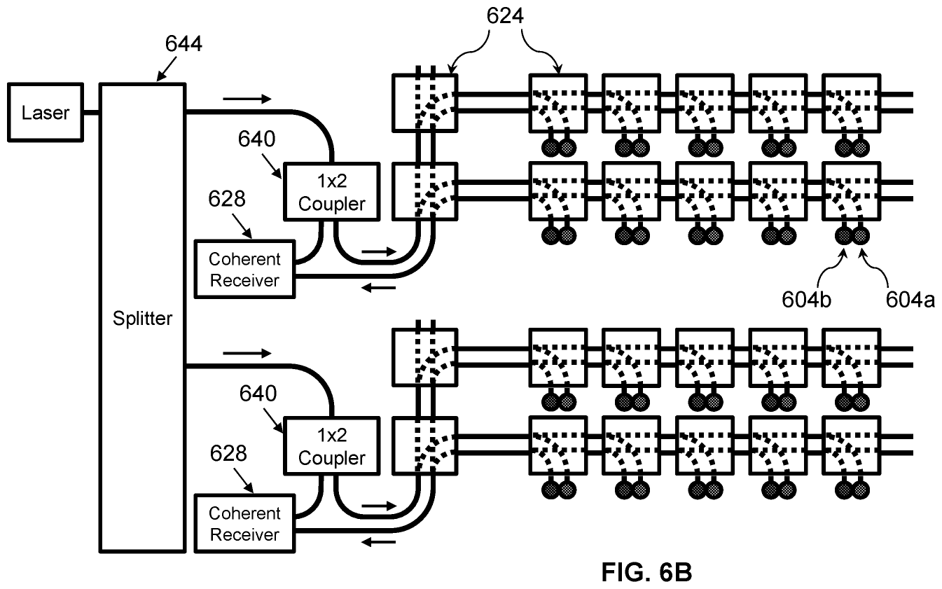

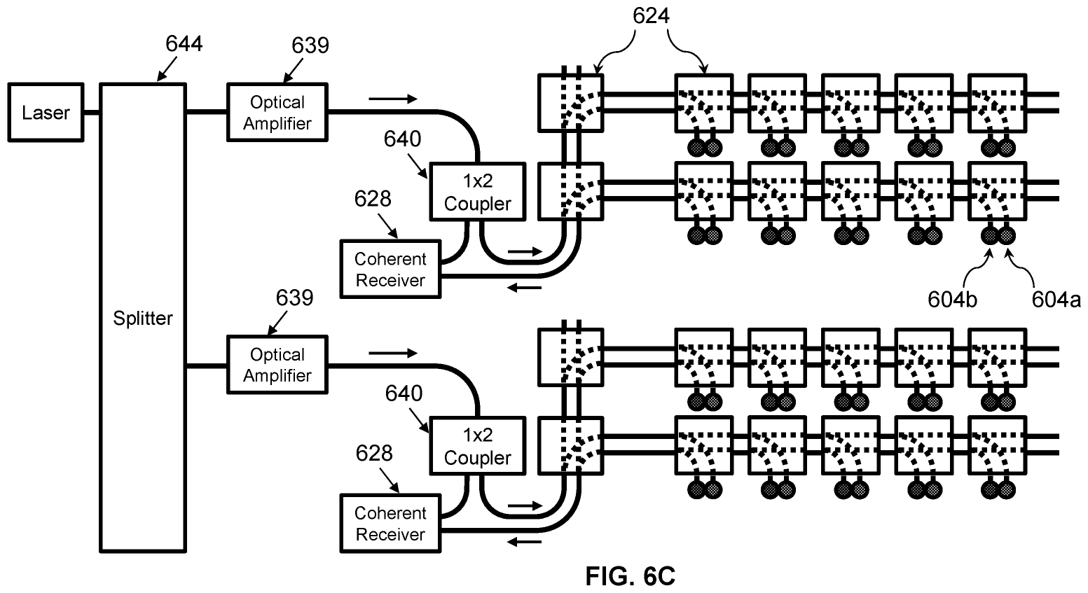

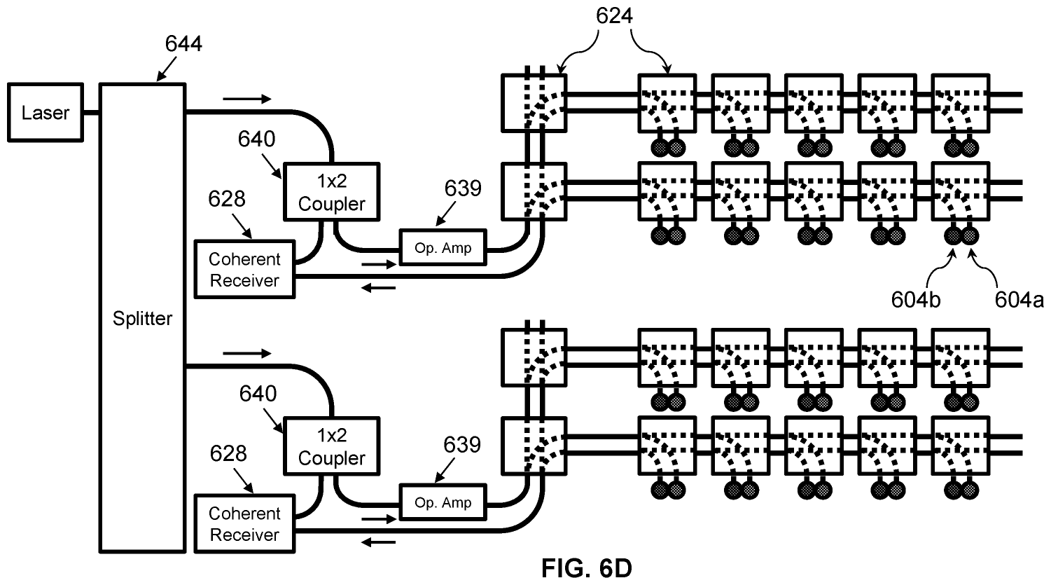

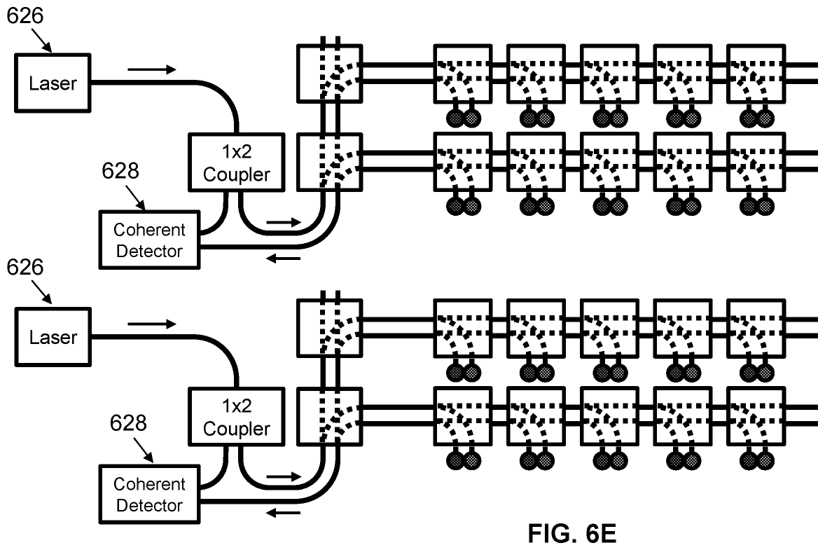

Multiple lasers and detectors can be used to speed up the operation of the imaging LiDAR. In FIG. 6A, a coherent receiver 628 is integrated into each pixel 642 of the array. For purposes of the description, we refer to a pixel here as including a transmit antenna 604a, a receive antenna 604b, a coherent receiver 628, a 1×2 coupler 640, and a switch 624 (single channel). As shown, the architecture can include an array of pixels. The laser power is delivered to the selected pixel by an optical switching network as described above. In addition to the coherent detector, the pixel comprises a Tx optical antenna 604a, an Rx optical antenna 604b, and a 1×2 coupler 640. The 1×2 coupler at each pixel location taps a small portion of the optical power from the laser 626 as a local oscillator (LO) for each respective coherent receiver. In this architecture, since the programmable optical network is only delivering the laser power to the selected pixel, only single channel switches 624 are needed. The received optical signal is converted to electrical signal at the pixel level. The electrical signal can be collected in a variety of ways. In the simplest case, all signals can be added together before sending to a common signal processor. Alternatively, the detected signals can be summed over a sub-group of pixels, e.g., a single row or a single column, or part of a row or part of a column, or a block of pixels spanning part of the rows and columns.

In another embodiment, a row/column addressing circuit can be used to read the detected signal from the active pixel. The detector addressing circuit can be synchronized with the programmable optical network to select the same pixel. In all cases, it might be advantageous to integrate a pre-amplifier in the pixel or for a sub-group of pixels to improve the signal-to-noise ratios and increase the operation speed.

Alternatively, instead of having a coherent receiver at each pixel, the coherent receiver 628 and 1×2 coupler 640 can be shared by a block of pixels, as illustrated in FIG. 6B. A network of switches 624 (dual channel) can couple the waveguides to the transmit antennas 604a and receive antennas 604b. In this embodiment, a splitter 644 can be used to split the laser or light signal into multiple signals that can be fed into multiple arrays, as shown. This simplify the complexity of the pixel, which allows higher density of pixels to be integrated on the same area. This will increase the resolution of the LiDAR without increasing the size of the sensing arca. Larger sensing area normally requires a larger optical lens. In this example, the laser power is distributed to each block by an integrated optical splitter.

Optical amplifiers 639 can be inserted between the optical splitter and the pixels as shown in the embodiment of FIG. 6C and FIG. 6D. The optical amplifiers can be placed either after the optical splitter (FIG. 6C) or after the 1×2 couplers (FIG. 6D).

Alternatively, instead of using a splitter as shown in the embodiment of FIG. 6B, multiple lasers 626 can be employed to increase the optical power emitted from each pixel. In the embodiment shown in FIG. 6E, one laser and one coherent receiver 628 are used for each block of pixels. In general, any number of lasers and any number of detectors can be used with the programmable optical antenna array.

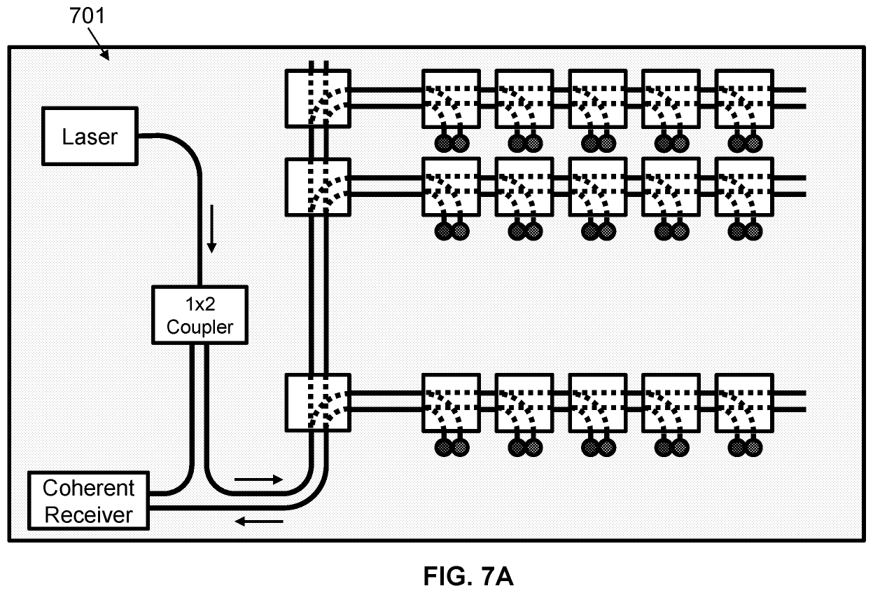

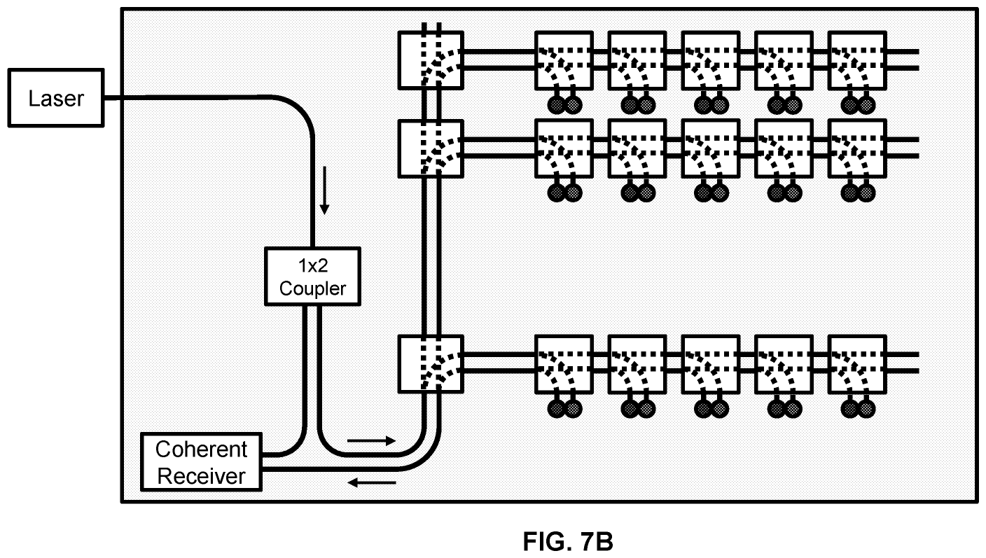

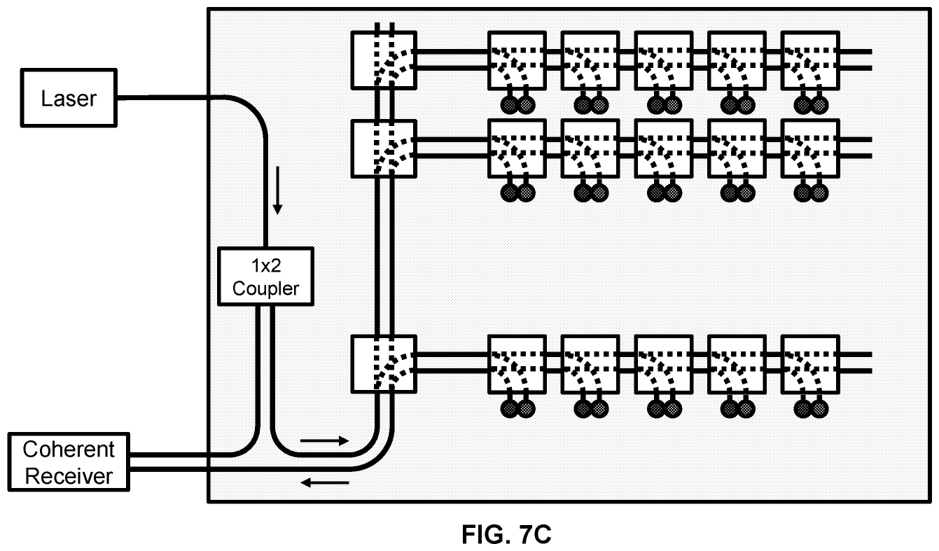

The optical antennas and the programmable optical network can be integrated on a single photonic integrated circuit, for example, using silicon photonics technology or other PIC platforms based on silicon nitride, silica, or III-V materials. The lasers and the detectors can be either integrated on the same PIC 701 (FIG. 7A) or located off chip and connected by fibers or other waveguides (FIGS. 7B and 7C). In another embodiment, the lasers and the detectors are integrated on a first PIC 701a such as III-V PIC, the array and other components are integrated on a second PIC 701b, and the two PICs are directly coupled to each other (FIG. 7D) or connected optical fibers. In another embodiment, the two PICs could be coupled to each other through free-space optical elements such as lenses or lens arrays. Optical isolators can be inserted between the lasers and the PIC 701b to suppress undesirable reflections to the lasers.

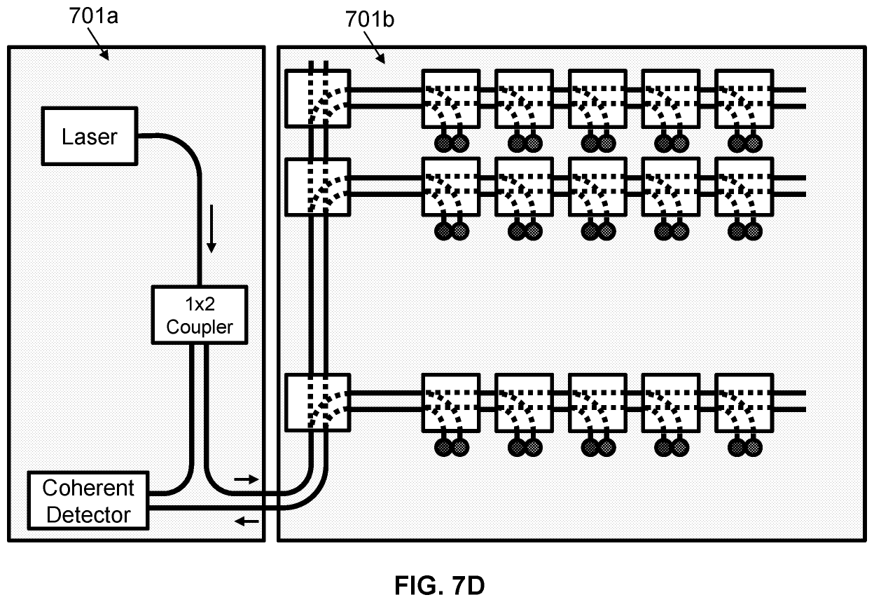

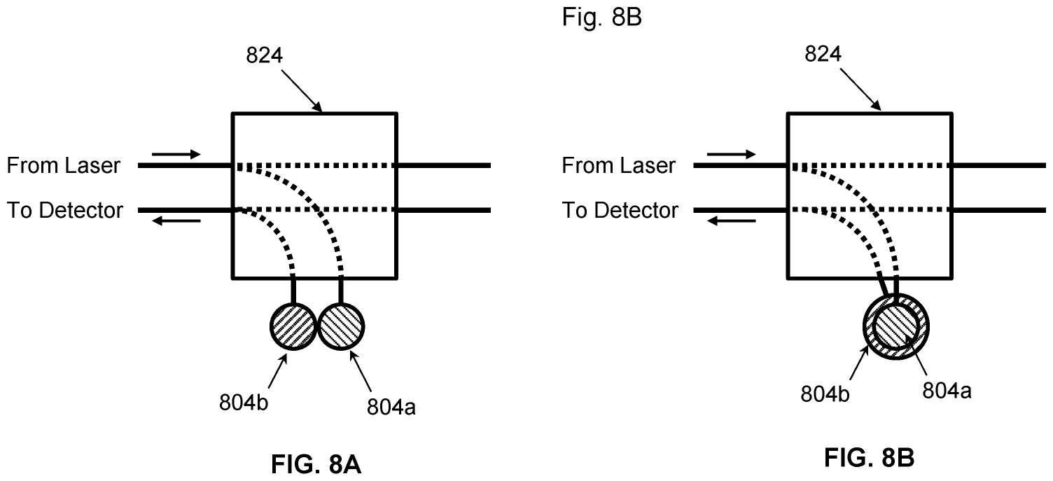

As described above, the transmit optical antenna and the receive optical antenna for each pixel can be offset either in the X/Y direction (side by side) or the Z direction (vertically stacked) to minimize the crosstalk between the Tx and Rx signals. The Tx antenna 604a and Rx antenna 604b can be either integrated side by side (FIG. 8A) or stacked vertically (FIG. 8B). Since the imaging LiDAR maps each lateral location in the focal plane to a different far field angle, there is a small offset between the Tx and Rx angles. This angle is sufficiently small and should still overlap on targets. To reduce the angular offset, the Tx and Rx antennas can be stacked vertically, as shown in FIG. 8B. In this embodiment, the Tx and Rx antennas are designed to operate with orthogonal polarizations. They are fabricated on different optical layers to minimize the crosstalk between the antennas.

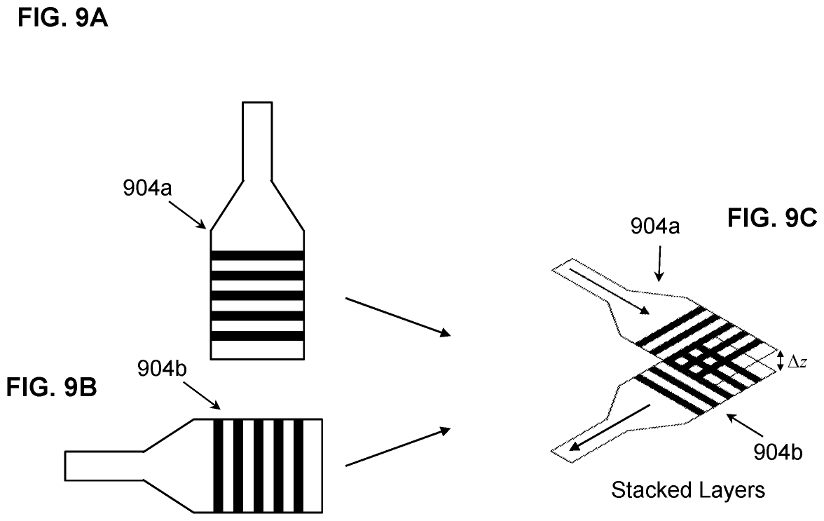

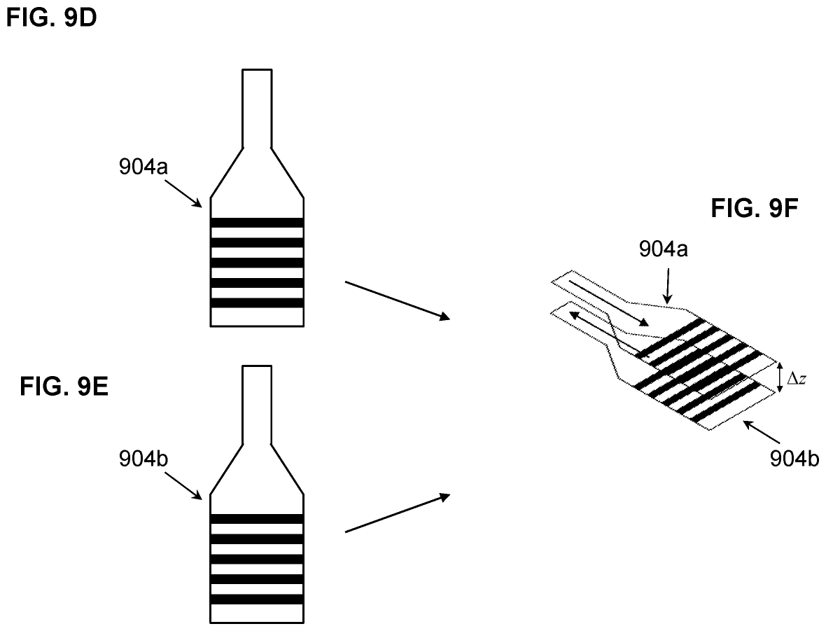

One embodiment of the vertically stacked antennas is shown in FIGS. 9A-9C. In this embodiment, each antenna is designed to operate in one polarization. As shown, the transmit optical antenna 904a is designed to operate in a first polarization, and the receive optical antenna is rotated by 90 degrees relative to the transmit optical antenna so it will transmit or receive in an orthogonal or second polarization. FIGS. 9A-9B shows the transmit and receive antennas separate, and FIG. 9C shows the antennas rotated orthogonally and vertically stacked on each other. The antennas are separated by a distance Δz (on the order of micrometers) in the vertical direction (along the optical axis of the lens) to minimize the crosstalk between the antennas. In another embodiment of the vertically stacked antennas, the two optical antennas are designed to operate in two orthogonal polarizations for Tx and Rx, respectively, in which the two antennas are aligned parallelly without the 90-degree rotation (FIGS. 9D-9F).

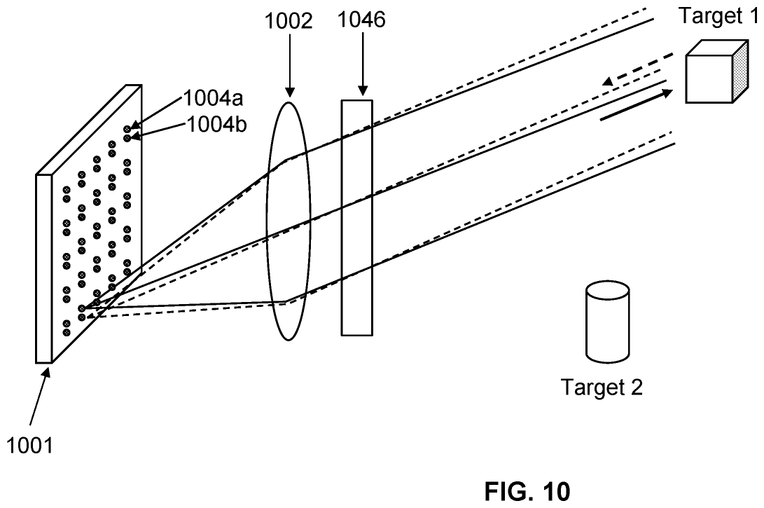

One embodiment of the imaging LiDAR employs a quarter-wave plate 1046 between the antennas (e.g., Tx antennas 1004a and Rx antennas 1004b) and the targets, as shown in FIG. 10. The quarter-wave plate can be inserted before or after the lens 1002. In this embodiment, the Tx and the Rx antennas have orthogonal polarizations. The emitted light pass through the quarter-wave plate. The reflected light from the target passes through the quarter-wave plate again before reaching the Rx antenna. The polarization is rotated by 90 degrees when reaching the Rx antenna. This embodiment has minimum optical losses in the optical path.

Yet another embodiment of the imaging LiDAR uses polarization-diversity receivers. Sometimes the light reflected from target is depolarized. A polarization-diversity receiver will be able to capture reflected light in both polarizations. In this embodiment, light emits in one polarization, but the Rx has two antennas, one with polarization parallel to that of the emitted light and the other with orthogonal polarization. The output of each antenna is mixed with an LO tapped off from the laser and detected by its own coherent receiver.

The systems and methods described herein can be used, for example, to perform range (distance) measurement in multiple directions. Additionally, the systems and methods described herein can be used to perform measurement of 3D point clouds. In some embodiments, the frame rate or speed of 3D point cloud measurement can be increased by turning on multiple pixels at the same time. In some examples, these multiple pixels can be powered by the same laser through an optical splitter. In other embodiments, the multiple pixels can be powered by separate lasers.

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

1.-20. (canceled)

21. A photonic integrated circuit (PIC) device, comprising:
a substrate;
an optical antenna array disposed on the substrate, the optical antenna array comprising a plurality of paired optical antennas each comprising a transmit optical antenna configured to transmit light towards a target and a receive optical antenna configured to receive light from the target; and
a programmable optical network disposed on the substrate and configured to provide a first light path to a selected transmit optical antenna, the programmable optical network being further configured to provide a separate second light path from a receive optical antenna paired to the selected transmit optical antenna.

22. The device of claim 21, further comprising at least one light emitter optically coupled to the programmable optical network, the at least one light emitter being configured to transmit light through the first light path to the selected transmit optical antenna.

23. The device of claim 22, wherein the at least one light emitter is integrated on the substrate.

24. The device of claim 22, wherein the at least one light emitter is integrated on a separate second substrate that is coupled to the substrate.

25. The device of claim 22, wherein the at least one light emitter is a frequency-modulated continuous-wave laser.

26. The device of claim 21, further comprising at least one light detector optically coupled to the programmable optical network, the at least one light detected being configured to receive light through the second light path from the receive optical antenna.

27. The device of claim 26, wherein the at least one light detector is integrated on the substrate.

28. The device of claim 26, wherein the at least one light detector is integrated on a separate second substrate that is coupled to the substrate.

29. The device of claim 26, wherein the at least one light detector is a coherent optical receiver.

30. The device of claim 21, wherein the transmit optical antenna and the receive optical antenna for each of the plurality of paired optical antennas are displaced on the substrate from each other.

31. The device of claim 30, wherein each transmit optical antenna and receive optical antenna of the plurality of paired optical antennas are displaced side by side on a common optical layer of the substrate.

32. The device of claim 30, wherein each transmit optical antenna and receive optical antenna of the plurality of paired optical antennas are displaced vertically on separate optical layers of the substrate.

33. The device of claim 22, wherein the at least one light detector is shared by a plurality of pixels, each pixel comprising:
the selected transmit optical antenna;
the receive optical antenna paired to the selected transmit optical antenna;
a dual-channel 1×2 optical switch comprising two parallel switches connecting an optical bus waveguide to the selected transmit optical antenna and a second optical bus waveguide connected to the receive optical antenna paired to the selected transmit optical antenna.

34. The device of claim 33, wherein optical energy from the at least one light emitter is delivered to multiple selected pixels through an optical splitter or optical amplifier.

35. The device of claim 33, wherein a separate light emitter is used for each group of pixels.

36. A method of transmitting and receiving light through a photonic integrated circuit (PIC), comprising:
controlling a programmable optical network on the PIC to provide a first light path from at least one light emitter to a selected transmit optical antenna of a paired optical antenna of the optical network;
transmitting light from the selected transmit optical antenna towards a target;
receiving reflected light from the target with a receive optical antenna that is paired to the selected transmit optical antenna; and
controlling the programmable optical network to provide a separate second light path from the receive optical antenna to at least one light detector.

37. The method of claim 36, wherein controlling the programmable optical network comprises actuating one or more MEMS switches.

38. The method of claim 37, wherein actuating the one or more MEMS switches further comprises energizing one or more electrodes disposed within the one or more MEMS switches.

39. The method of claim 36, further comprising delivering optical energy from the at least one light emitter to multiple selected pixels through an optical splitter.

40. The method of claim 36, further comprising acquiring three-dimensional images by combining range measurements of multiple pixels.
